(19) United States
(12) Patent Application Publication
(10) Pub. No.: US 2017/0093653 A1
(43) Pub. Date: Mar. 30, 2017

(54) Far Side CQI

(71) Applicant: Microsoft Technology Licensing, LLC, Redmond, WA (US)

(72) Inventors: Robert Andreas Aichner, Bellevue, WA (US); Matthew Benjamin Blank, London (GB); Martin Koo Rosenmejer, London (GB)

(21) Appl. No.: 14/870,950

(22) Filed: Sep. 30, 2015

(51) Int. Cl. H04L 12/26; H04L 29/08

(52) U.S. Cl. CPC H04L 43/045; H04L 43/08; H04L 67/36

(57) ABSTRACT

There is provided an apparatus comprising: at least one processor; and a memory comprising code that, when executed on the at least one processor, causes the apparatus to: communicate with at least one other apparatus via a network apparatus; receive from the network apparatus for each of said at least one other apparatus an indication of a transmission link quality of a link extending from said at least one other apparatus to the apparatus; and display the received transmission link quality indication(s).

Users commonly use user terminals, such as mobile phones, desktop computers, laptops, tablets, phablets and the like, to communicate with other user terminals. One way of communicating involves making audio and/or visual calls over a network. Audio and/or visual calls between two user terminals may be coordinated through a network apparatus (herein used to denote an apparatus located in the network upstream of the user terminals, such as a server).

The network apparatus receives data packets comprising audio and/or visual data from a first user terminal for transmission to a second user terminal. The network apparatus further receives data packets comprising audio and/or visual data from the second user for transmission to the first user. The network apparatus can therefore be said to facilitate the communications between the first and second user terminals. The network apparatus may also facilitate communications between multiple (i.e. more than two) user terminals. For example, the network apparatus may coordinate an audio and/or visual call in which data packets comprising audio and/or visual data are received from each user terminal of a plurality of user terminals and those received data packets are subsequently transmitted to others of the plurality of user terminals.

Over the course of an audio/visual call, the quality of the links between each of the user terminals and the network apparatus may alter in real time. This alteration in the link quality may be manifest to a user of a user terminal by variations in the output of the call through a display screen of the user terminal. To address this, the user terminal may locally determine an indication of a call quality, using, for example, a measure of the lost/dropped packets (which may be determined from the header information), which is displayed to a user using the display of the user terminal.

### SUMMARY

The inventors have realised that, to a user viewing/receiving an audio and/or visual call having a variable call quality, it is difficult to know exactly where in the network the link may have varied and so it is difficult to perform any rectifying action to remedy a deteriorating link. For example, where a displayed call indication shows that an audio stream from a user terminal on the call is experiencing a deteriorating link quality, a user viewing the displayed call indication has no idea which link is negatively affecting the call. This may lead to user assuming that a different end to the call is experiencing link problems, which can further lead to problems when the user undertakes any troubleshooting actions.

According to a first aspect, there is provided an apparatus comprising: at least one processor; and a memory comprising code that, when executed on the at least one processor, causes the apparatus to: communicate with at least one other apparatus via a network apparatus; receive from the network apparatus for each of said at least one other apparatus an indication of a transmission link quality of a link extending from said at least one other apparatus to the apparatus; and display the received transmission link quality indication(s).

The indication(s) of the transmission link quality may be indicative of a link quality from said at least one other apparatus to the network apparatus.

The apparatus may be further caused to: receive from the network apparatus an indication of a receive link quality of a link extending from the network apparatus to the apparatus and/or a transmit link quality of a link extending from the apparatus to the network apparatus; and display the received indication of the receive link quality and/or transmit link quality.

The apparatus may be further caused to: receive an input from a user in response to a display of at least one of said indications; and in response to the received input, cause a property of the communication with said at least one other apparatus to be altered and/or investigated.

The apparatus may be further caused to display at least one of said received indications by causing a display screen of the apparatus to render said indication immediately adjacent to a region of the display associated with a user associated with the apparatus to which said rendered indication relates.

The display of said indication(s) may be rendered as a predetermined colour on a display of the apparatus. The display of said indication(s) may be only rendered as a predetermined colour on the display of the apparatus. An indication of a bad link quality may be indicated by display of a red colour whilst an indication of a good link quality is indicated by display of a green colour.

The display of said indication(s) may be only provided to the user on receipt of a user input to the apparatus requesting said display.

The apparatus may be caused to: communicate with a plurality of other apparatuses via a network apparatus; and display a plurality of received indications of transmission link qualities, wherein each indication is associated with a respective other apparatus and is indicative of a transmission link quality of a link extending from the respective other apparatus to the network apparatus.

According to a second aspect, there is provided a network apparatus comprising: at least one processor; and a memory comprising code that, when executed on the at least one processor, causes the apparatus to: facilitate communications between a plurality of apparatus, including a first apparatus and a second apparatus, via a plurality of links; collect information on the quality of each of said plurality of links; and provide an indication to the second apparatus on the quality of a transmission link from the first apparatus to the second apparatus.

The indication of the transmission link quality may be indicative of a link quality from the first apparatus to the network apparatus.

The network apparatus may be further caused to: transmit to the second apparatus an indication of a receive link quality of a link communicating data from the network apparatus to the second apparatus; and/or transmit to the second apparatus an indication of a transmit link quality of a link communicating data from the second apparatus to the network apparatus.

The network apparatus may be further caused to: provide an indication to the second apparatus of the quality of a transmission link from a third apparatus of the plurality of apparatus to the second apparatus.

The network apparatus may be further caused to: compare said collected information to at least one threshold for determining what indication should be provided to the second apparatus.

According to a third aspect, there is provided a method comprising: communicating, by an apparatus, with at least one other apparatus via a network apparatus; receiving, by the apparatus, from the network apparatus for each of said at least one other apparatus an indication of a transmission link quality of a link extending from said at least one other apparatus to the apparatus; and causing, by the apparatus, a display of the received transmission link quality indication(s).

The indication(s) of the transmission link quality may be indicative of a link quality from said at least one other apparatus to the network apparatus.

The method may further comprise: receiving from the network apparatus an indication of a receive link quality of a link extending from the network apparatus to the apparatus; and displaying the received indication of the receive link quality.

The method may further comprise: receiving an input from a user in response to a display of at least one of said indications; and in response to the received input, causing a property of the communication with said at least one other apparatus to be altered and/or investigated.

The apparatus may be caused to display at least one of said received indications by causing a display screen of the apparatus to render said indication immediately adjacent to a region of the display associated with a user associated with the apparatus to which said rendered indication relates.

### FIGURES

For a better understanding of the subject matter and to show how the same may be carried into effect, reference will now be made by way of example only to the following drawings in which:

FIG. 1 is a schematic illustration of a communication system;

FIG. 2 is a schematic block-diagram of a user terminal;

FIG. 3 is a schematic illustration of the presently described system;

FIG. 4 is a flow chart of operations that may be performed by a user terminal according to the presently described system; and

FIG. 5 is a flow chart of operations that may be performed by a network apparatus according to the presently described system

### DETAILED DESCRIPTION

The following relates to the situation in which a first user is conducting a real-time audio and/or visual call via a centralised network apparatus with at least one other user using respective user terminals (although it is understood that the following is not limited to these situations). Further, the following relates to the display of a call quality indication that is displayed to each user via their respective user terminal. The call quality indications represent indications of the quality of the links between each of the user terminals on the call and the network apparatus. This displayed quality information may be used to indicate the origin in the network of a degradation in the call quality and to take remedial action in respect of a deteriorating link quality. For example, assume User A is communicating with User B via a network apparatus. If only the uplink quality between User B and the network apparatus is poor, this information may be imparted to User A by indicating that User B has a bad link quality whilst User A has a good link quality. To User B, it may appear as though User B's link is good (as the receive link quality from the server may be good). However, User B's user terminal is configured to indicate to User B that User B has a bad link, whilst User A has a good link. Thus User B is made aware that he may have some transmit quality problems and may initiate troubleshooting and/or mediation of the upstream link between User B's terminal and the server. Consequently, there is provided in the following a manner of differentiation between the quality of the different links between the different user devices and the central network apparatus during an audio and/or visual call.

In order that the environment in which the present system may operate be understood, by way of example only, we describe a potential communication system and user equipment into which the subject-matter of the present application may be put into effect. It is understood that the exact layout of this network is not limiting.

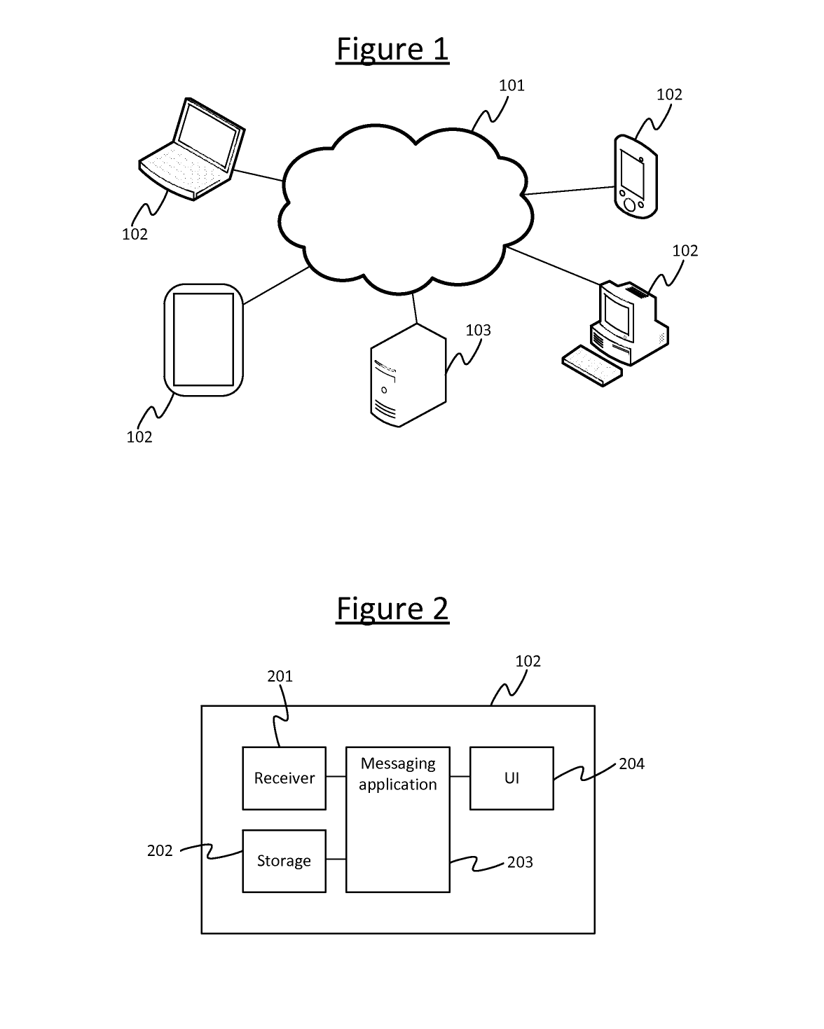

FIG. 1 shows an example of a communication system in which the teachings of the present disclosure may be implemented. The system comprises a communication medium 101, in embodiments a communication network such as a packet-based network, for example comprising the Internet and/or a mobile cellular network (e.g. 3GPP network). The system further comprises a plurality of user terminals 102, each operable to connect to the network 101 via a wired and/or wireless connection. For example, each of the user terminals may comprise a smartphone, tablet, laptop computer or desktop computer. In embodiments, the system also comprises a network apparatus 103 connected to the network 101. It is understood, however, that a network apparatus may not be used in certain circumstances, such as some peer-to-peer real-time communication protocols. The term network apparatus as used herein refers to a logical network apparatus, which may comprise one or more physical network apparatus units at one or more physical sites (i.e. the network apparatus 103 may or may not be distributed over multiple different geographic locations).

FIG. 2 shows an example of one of the user terminals 102 in accordance with embodiments disclosed herein. The user terminal 102 comprises a receiver 201 for receiving data from one or more others of the user terminals 102 over the communication medium 101, e.g. a network interface such as a wired or wireless modem for receiving data over the Internet or a 3GPP network. The user terminal 102 also comprises a non-volatile storage 202, i.e. non-volatile memory, comprising one or more internal or external non-volatile storage devices such as one or more hard-drives and/or one or more EEPROMs (sometimes also called flash memory). Further, the user terminal comprises a user interface 204 comprising at least one output to the user, e.g. a display such as a screen, and/or an audio output such as a speaker or headphone socket. The user interface 204 will typically also comprise at least one user input allowing a user to control the user terminal 102, for example a touch-screen, keyboard and/or mouse input.

Furthermore, the user terminal 102 comprises a messaging application 203, which is configured to receive messages from a complementary instance of the messaging application on another of the user terminals 102, or the network apparatus 103 (in which cases the messages may originate from a sending user terminal sending the messages via the network apparatus 103, and/or may originate from the network apparatus 103).

The messaging application is configured to receive the messages over the network 101 (or more generally the communication medium) via the receiver 201, and to store the received messages in the storage 202. For the purpose of the following discussion, the described user terminal 102 will be considered as the receiving (destination) user terminal, receiving the messages from one or more other, sending ones of the user terminals 102. Further, any of the following may be considered to be the entity immediately communicating with the receiver: as a router, a hub or some other type of access node located within the network 101. It will also be appreciated that the messaging application 203 receiving user terminal 102 may also be able to send messages in the other direction to the complementary instances of the application on the sending user terminals and/or network apparatus 103 (e.g. as part of the same conversation), also over the network 101 or other such communication medium.

The messaging application may transmit audio and/or visual data using any one of a variety of communication protocols/codecs. For example, audio data may be streamed over a network using a protocol known Real-time Transport Protocol, RTP (as detailed in RFC 1889), which is an end-to-end protocol for streaming media. Control data associated with that may be formatted using a protocol known as Real-time Transport Control Protocol, RTCP (as detailed in RFC 3550). Session between different apparatuses may be set up using a protocol such as the Session Initiation Protocol, SIP.

The following describes an apparatus, such as a user terminal, that comprises at least one processor and a memory comprising code that, when executed on the at least one processor, causes the apparatus to: communicate with at least one other apparatus (i.e. at least one other user terminal) via a network apparatus, such as a server. The apparatus may be further caused to receive from the network apparatus for each of said at least one other apparatus an indication of a transmission link quality of a link extending from said at least one other apparatus to the apparatus and to display the received transmission link quality indication(s). The received transmission link quality indication is displayed using a display screen operatively connected to the apparatus that receives the transmission link quality information from the network apparatus. The apparatus may be further caused to communicate with a plurality of other apparatuses (other user terminals) via a network apparatus and to display a plurality of received indications of transmission link qualities, wherein each received indication is associated with a respective one of the plurality of other apparatuses and is indicative of a transmission link quality of a link extending from the respective other apparatus to the network apparatus.

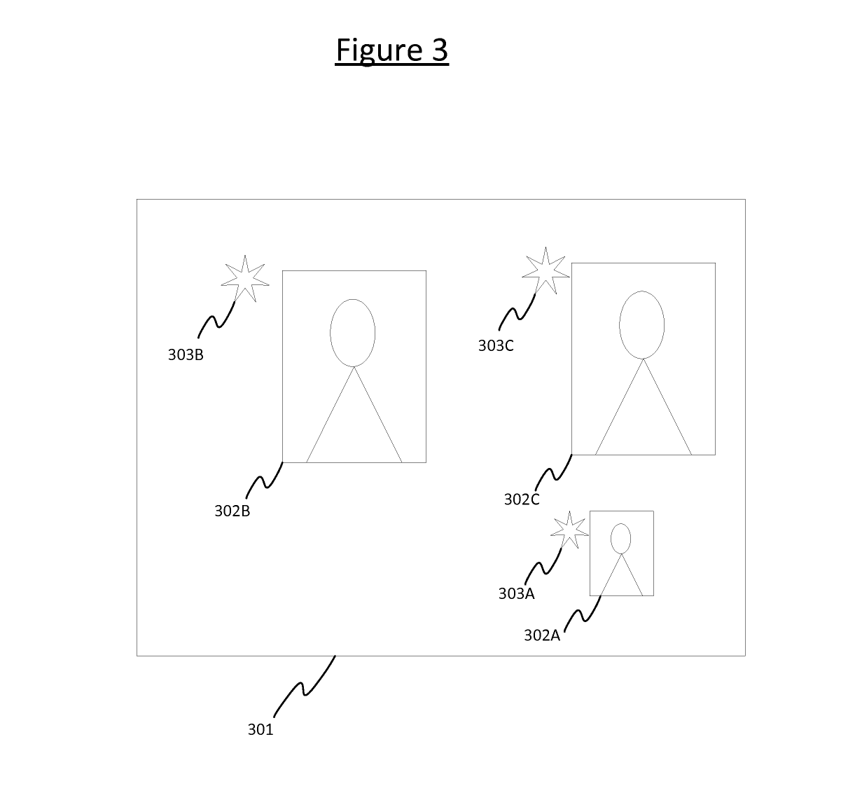

For example, we assume that a user terminal A is communicating data packets with a user terminal B and a user terminal C via a server. The user terminal A receives from the server an indication of the link quality between the user terminal B and the user terminal A, which may consist of an indication of both a quality of the link upstream from the user terminal B to the server and a quality of the link downstream from the server to the user terminal A, or alternatively, which may consist of an indication of a quality of the link upstream from the user terminal B to the server. In more general terminology, this second case corresponds to the situation in which the indication(s) of the transmission link quality is indicative of a link quality from said at least one other apparatus to the network apparatus. In other words, the second case corresponds to the case in which the provided indication being considered is wholly (or solely) indicative of the quality of the upstream link from the at least one other apparatus to the network apparatus. The user terminal A also receives from the server an indication of the link quality between the user terminal C and the user terminal A, which may consist of an indication of both the quality of the link upstream from the user terminal B and the server and the quality of the link downstream from the server to the user terminal A, or alternatively, which may consist of an indication of the quality of the link upstream from the user terminal C to the server. In response to these received indications, the user terminal A is configured to output a representation of these received indications to a display operatively connected to the user terminal A. A possible display screen operatively connected to the user terminal A in this scenario is depicted in FIG. 3.

On the display screen 301 of FIG. 3, there is depicted a representation 302B of user B associated with the user terminal B and a representation 302C of user C associated with the user terminal C Immediately adjacent to the region on the display of representation 302B, there is presented an indication 303B that is indicative of the received link quality for the link between the user terminal B and the user terminal A Immediately adjacent to the region on the display of representation 302C, there is presented an indication 303C that is indicative of the received link quality for the link between the user terminal C and the user terminal A.

Also shown on the display screen 301 of FIG. 3, is a representation 302A of the user A of the user terminal A (i.e. of the user terminal operatively connected to the display screen) Immediately adjacent to the region on the display of representation 302A, there is presented an indication 303A that is indicative of a received link quality for the downstream and/or upstream link between the server and the user terminal A. Thus the server may also further configured to provide to the user terminal A an indication of the link quality of the downstream link from the server to the user terminal A and/or of the link quality of the upstream from the user terminal A to the server. In general terminology, this may be described as the apparatus being further caused to receive from the network apparatus an indication of a receive link quality of a link extending from the network apparatus to the apparatus and/or being caused to receive from the network apparatus an indication of a transmit link quality of a link extending from the apparatus to the network apparatus. The apparatus is caused to display the received indication(s) of the receive and/or transmit link quality.

In the above described scenarios, reference has been made to presenting indications 303A to 303C immediately adjacent to respective regions on the display of representations 302A to 302C of users A to C. It is understood that this is not intended to be limiting on the form and/or location of the presented indications. For example, the user terminal A may be caused to superpose the presented indications 303A to 303B respectively over the representations 302A to 302C of users A to C. This superposition may be partial or complete over the representations 302A to 302C of users A to C. In other word, only a part of the representations 302A to 302C of users A to C may be covered or the entire representations 302A to 302C of users A to C may be covered. The superposition and/or presentation in general may be continuous throughout the call and/or operate only in response to a request. The term “request” is used here to denote the receipt of a user input that causes the presentation of the indication to be made, such as is described further below.

In the above discussed examples, the presented indications are respectively displayed in proximal location to representations 302A to 302C of users A to C that are present during a real-time audio and/or visual call. This is useful as it provides, to an observing user A of the user terminal A, an immediate association between the indications and the users B to C with whom the user A is communicating. This proximal location embodiment also provides an efficient use of space on the display screen. It is understood, however, that the presented indications may be presented to user A using a drop down menu. The drop down menu may unfold following an inputted instruction to that effect from user A into the user terminal A. Such an arrangement also has an effect of rendering the display on the display screen efficient, as the information provided by the indications is presented to the user when desired by the user, which would usually be in response to a particular deterioration in the call quality from at least one of the users A to C. It is further understood that the user terminal A may be configured to only cause the display of said indication(s) on receipt of a user input from user A to the user terminal A requesting said display.

The presented indications may thus be located in a number of different locations (either simultaneously or in the alternate). Now, useful forms of the presented indications are discussed.

One useful form of the presented indication is to cause the indication to be conveyed through use of a particular colour. For example, the use of a red colour may be used to indicate that a link has a bad link quality, the use of a green colour may be used to indicate that a link has a good link quality and the use of a yellow colour may be used to indicate that a link has an intermediate link quality. In one embodiment, only two colours are used i.e. a link quality is only indicated as being “good” or “bad”.

The determination of whether a link is “good” or “bad” (or, indeed, “intermediate”) may be performed with reference to set thresholds. The thresholds may be set in the network, or at a user terminal. Where the thresholds are set in the network, the network apparatus/server may usefully only indicate to each of the plurality of user terminals that a link is “good”, “bad”, etc., without providing any additional degree of information on the state of the link under consideration. This reduces the amount of bandwidth that the network apparatus requires to provide a user terminal with an indication of the quality of a particular link, compared to the case where actual values (such as packet loss rate, etc.) are provided to the user terminal A.

Following display of the presented indications to the user A on the display screen 301, the user A may determine that some rectifying action and/or troubleshooting needs to be performed in order to improve the link quality. To signal this to the user terminal A, the user terminal A is arranged to receive an input from the user A. The received input may be indicative of a particular link that the user A would like to apply the rectifying action and/or troubleshooting to.

In response to this received input, the user terminal A may be arranged to investigate possible actions for improving the properties of a particular communication link. For example, one action that may be taken by the user terminal A is to send an instruction and/or a request to the server to alter the modulation and/or coding properties of a link identified by the user A as needing an improvement to the quality. Thus, in more general terminology, the apparatus may be further caused to receive an input from a user in response to a display of at least one of said indications. In response to the received input, the apparatus is further caused to cause a property of the communication with said at least one other apparatus to be altered and/or investigated.

Now, some particular features associated with the network apparatus/server will be discussed. In general, there is provided a network apparatus comprising at least one processor; and a memory comprising code that, when executed on the at least one processor, causes the apparatus to: facilitate communications between a plurality of apparatus, including a first apparatus and a second apparatus, via a plurality of links. The network apparatus is further caused to collect information on the quality of each of said plurality of links and to provide an indication to the second apparatus on the quality of a transmission link from the first apparatus to the second apparatus. The network apparatus may be further caused to provide an indication to the second apparatus of the quality of a transmission link from a third apparatus of the plurality of apparatus to the second apparatus.

A specific example in which a server (as a network apparatus) facilitates and/or coordinates communications between the user terminals A to C (each associated with a respective the users A to C) is now provided.

The server is configured to receive data packets from each of the user terminals A to C that are intended to be distributed to the other user terminals. For example, data packets from the user terminal B are for further distribution to the user terminals A and C. Data packets from the user terminal C are for further distribution to the user terminals A and B. Data packets from the user terminal A are for further distribution to the user terminals B and C. The server may, on receiving these data packets, be caused to determine a link quality of each upstream link from each user terminal A to C to the server. The server may be further configured to receive, from each user terminal, an indication of the downstream link quality from the server to that user terminal. The server may in addition, or instead of receiving an indication of the downstream link qualities, determine downstream link qualities itself (e.g. through repeat request procedures).

In dependence on these determined link qualities, the server is configured to provide an indication of the determined link qualities to each of the user terminals. In particular, the server is configured to provide to user terminal A an indication of the link quality along the link from the user terminal B to the server, along the link from the user terminal C to the server, and from the server to the user terminal A. In other words, for each user terminal of the communicating plurality of user terminals, the server is configured to provide respective indications for the links extending from the other user terminals to the each user terminal. As mentioned above in the discussions relating to the operation of the user terminals, the indication of the link quality from the user terminal B to the user terminal A may consist of an indication of both the quality of the link upstream from the user terminal B to the server and the quality of the link downstream from the server to the user terminal A, or alternatively, which may consist of an indication of the quality of the link upstream from the user terminal B to the server. In more general terminology, this second case corresponds to the situation in which the indication(s) of the transmission link quality is indicative of a link quality from said at least one other apparatus to the network apparatus. In other words, the second case corresponds to the case in which the provided indication being considered is wholly (aka solely) indicative of the quality of the upstream link from the at least one other apparatus to the network apparatus.

The user terminal A also receives from the server an indication of the link quality between the user terminal C and the user terminal A, which may consist of an indication of both the quality of the link upstream from the user terminal C to the server and the quality of the link downstream from the server to the user terminal A, or alternatively, which may consist of an indication of the quality of the link upstream from the user terminal C to the server.

As further mentioned above, the server is configured for providing such indications to each of the plurality of user terminals A to C.

The server is further configured to compare said collected information to at least one threshold for determining what indication should be provided to the second apparatus. The threshold is as discussed above.

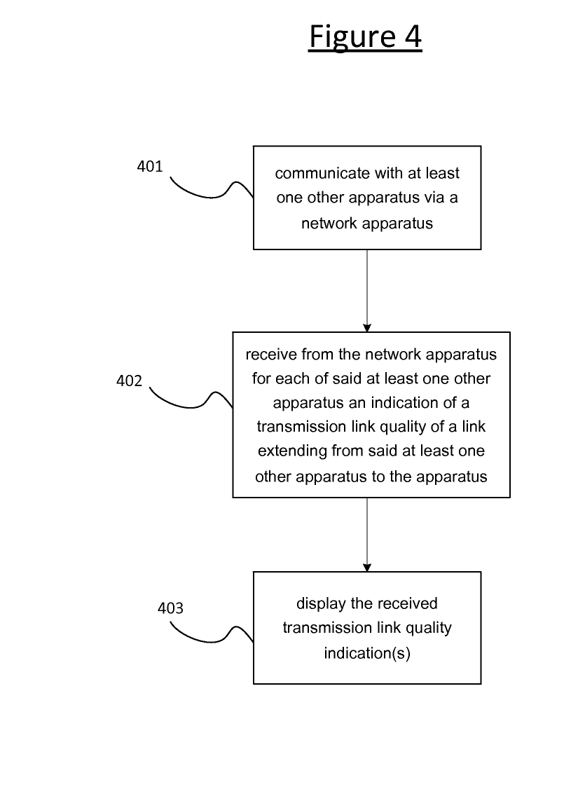

FIG. 4 is a flow chart illustrating potential operations performed by the user terminal. At step 401, the user terminal communicates with at least one other apparatus via a network apparatus, such as a server.

At step 402, the user terminal receives, from the network apparatus, for each of said at least one other apparatus an indication of a transmission link quality of a link extending from said at least one other apparatus to the user terminal.

At step 403, the user terminal displays the received transmission link quality indication(s) via a display screen operatively connected to the user terminal.

As in the case above, the transmission link quality may be indicative of a link quality from said at least one other apparatus to the network apparatus.

The user terminal may further receive, from the network apparatus, an indication of a receive link quality of a link extending from the network apparatus to the user terminal and display the received indication of the receive link quality.

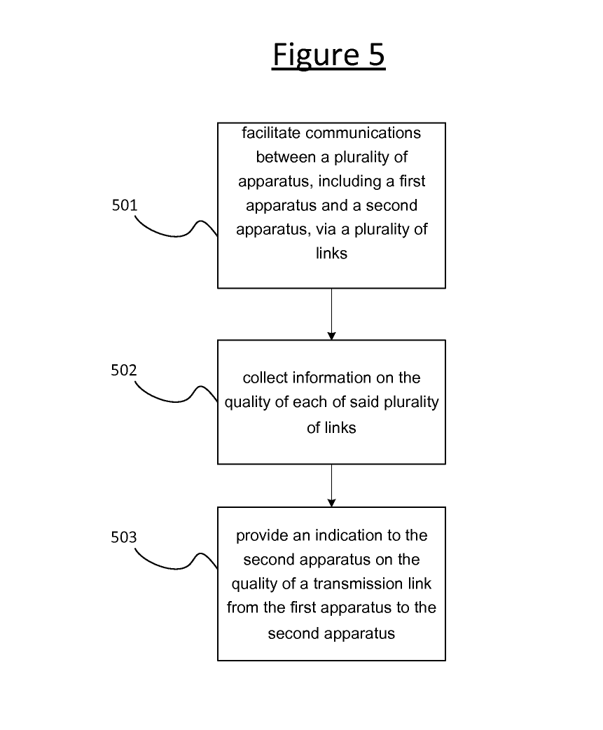

FIG. 5 is a flow chart illustrating some potential operations performed by the network apparatus.

At step 501, the network apparatus is configured to facilitate communications between a plurality of apparatus, including a first apparatus and a second apparatus, via a plurality of links.

At step 502, the network apparatus is configured to collect information on the quality of each of said plurality of links.

At step 503, the network apparatus is configured to provide an indication to the second apparatus on the quality of a transmission link from the first apparatus to the second apparatus.

It is understood that any number of the above-mentioned aspects may be combined in a single embodiment without any loss of generality.

The term “link” has been used above to describe a communications channel used for communicating packetized data between two communication devices (such as a network apparatus and a user terminal). The link may be a physical link or a logical link, that uses one or more logical links and may be described by a set of connection parameters.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). Where a particular device is arranged to execute a series of actions as a result of program code being executed on a processor, these actions may be the result of the executing code activating at least one circuit or chip to undertake at least one of the actions via hardware. At least one of the actions may be executed in software only. The program code can be stored in one or more computer readable memory devices. The features of the techniques described below are platform-independent, meaning that the techniques may be implemented on a variety of commercial computing platforms having a variety of processors.

For example, the user terminals configured to operate as described above may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

According to a first aspect, there is provided an apparatus comprising: means for communicating with at least one other apparatus via a network apparatus; means for receiving from the network apparatus for each of said at least one other apparatus an indication of a transmission link quality of a link extending from said at least one other apparatus to the apparatus; and means for displaying the received transmission link quality indication(s).

The indication(s) of the transmission link quality may be indicative of a link quality from said at least one other apparatus to the network apparatus.

The apparatus may further comprise: means for receiving from the network apparatus an indication of a receive link quality of a link extending from the network apparatus to the apparatus and/or a transmit link quality of a link extending from the apparatus to the network apparatus; and means for displaying the received indication of the receive link quality and/or transmit link quality.

The apparatus may further comprise: means for receiving an input from a user in response to a display of at least one of said indications; and in response to the received input, means for causing a property of the communication with said at least one other apparatus to be altered and/or investigated.

The apparatus may further comprise means for displaying at least one of said received indications by causing a display screen of the apparatus to render said indication immediately adjacent to a region of the display associated with a user associated with the apparatus to which said rendered indication relates.

The display of said indication(s) may be rendered as a predetermined colour on a display of the apparatus. The display of said indication(s) may be only rendered as a predetermined colour on the display of the apparatus. An indication of a bad link quality may be indicated by display of a red colour whilst an indication of a good link quality is indicated by display of a green colour.

The display of said indication(s) may be only provided to the user on receipt of a user input to the apparatus requesting said display.

The apparatus may further comprise: means for communicating with a plurality of other apparatuses via a network apparatus; and means for displaying a plurality of received indications of transmission link qualities, wherein each indication is associated with a respective other apparatus and is indicative of a transmission link quality of a link extending from the respective other apparatus to the network apparatus.

According to a second aspect, there is provided a network apparatus comprising: means for facilitating communications between a plurality of apparatus, including a first apparatus and a second apparatus, via a plurality of links; means for collecting information on the quality of each of said plurality of links; and means for providing an indication to the second apparatus on the quality of a transmission link from the first apparatus to the second apparatus.

The indication of the transmission link quality may be indicative of a link quality from the first apparatus to the network apparatus.

The network apparatus may further comprise means for: transmitting to the second apparatus an indication of a receive link quality of a link communicating data from the network apparatus to the second apparatus; and/or means for transmitting to the second apparatus an indication of a transmit link quality of a link communicating data from the second apparatus to the network apparatus.

The network apparatus may further comprise: means for providing an indication to the second apparatus of the quality of a transmission link from a third apparatus of the plurality of apparatus to the second apparatus.

The network apparatus may further comprise: means for comparing said collected information to at least one threshold for determining what indication should be provided to the second apparatus.

According to a third aspect, there is provided a method comprising: communicating, by an apparatus, with at least one other apparatus via a network apparatus; receiving, by the apparatus, from the network apparatus for each of said at least one other apparatus an indication of a transmission link quality of a link extending from said at least one other apparatus to the apparatus; and causing, by the apparatus, a display of the received transmission link quality indication(s).

The indication(s) of the transmission link quality may be indicative of a link quality from said at least one other apparatus to the network apparatus.

The method may further comprise: receiving from the network apparatus an indication of a receive link quality of a link extending from the network apparatus to the apparatus; and displaying the received indication of the receive link quality.

The method may further comprise: receiving an input from a user in response to a display of at least one of said indications; and in response to the received input, causing a property of the communication with said at least one other apparatus to be altered and/or investigated.

The apparatus may be caused to display at least one of said received indications by causing a display screen of the apparatus to render said indication immediately adjacent to a region of the display associated with a user associated with the apparatus to which said rendered indication relates.

1. An apparatus comprising:
at least one processor; and
a memory comprising code that, when executed on the at least one processor, causes the apparatus to:
communicate with at least one other apparatus via a network apparatus;
receive from the network apparatus for each of said at least one other apparatus an indication of a transmission link quality of a link extending from said at least one other apparatus to the apparatus; and
display the received transmission link quality indication(s).

2. An apparatus as claimed in claim 1, wherein the indication(s) of the transmission link quality is indicative of a link quality from said at least one other apparatus to the network apparatus.

3. An apparatus as claimed in claim 1, wherein the apparatus is further caused to:
receive from the network apparatus an indication of a receive link quality of a link extending from the network apparatus to the apparatus and/or a transmit link quality of a link extending from the apparatus to the network apparatus; and
display the received indication of the receive link quality and/or transmit link quality.

4. An apparatus as claimed in claim 1, wherein the apparatus is further caused to:
receive an input from a user in response to a display of at least one of said indications; and
in response to the received input, cause a property of the communication with said at least one other apparatus to be altered and/or investigated.

5. An apparatus as claimed in claim 1, wherein the apparatus is caused to display at least one of said received indications by causing a display screen of the apparatus to render said indication immediately adjacent to a region of the display associated with a user associated with the apparatus to which said rendered indication relates.

6. An apparatus as claimed in claim 1, wherein the display of said indication(s) is rendered as a predetermined colour on a display of the apparatus.

7. An apparatus as claimed in claim 6, wherein the display of said indication(s) is only rendered as a predetermined colour on the display of the apparatus.

8. An apparatus as claimed in claim 6, wherein an indication of a bad link quality is indicated by display of a red colour whilst an indication of a good link quality is indicated by display of a green colour.

9. An apparatus as claimed in claim 1, wherein the display of said indication(s) is only provided to the user on receipt of a user input to the apparatus requesting said display.

10. An apparatus as claimed in claim 1, wherein the apparatus is caused to:
communicate with a plurality of other apparatuses via a network apparatus; and
display a plurality of received indications of transmission link qualities, wherein each indication is associated with a respective other apparatus and is indicative of a transmission link quality of a link extending from the respective other apparatus to the network apparatus.

11. A network apparatus comprising:
at least one processor; and
a memory comprising code that, when executed on the at least one processor, causes the apparatus to:
facilitate communications between a plurality of apparatus, including a first apparatus and a second apparatus, via a plurality of links;
collect information on the quality of each of said plurality of links; and
provide an indication to the second apparatus on the quality of a transmission link from the first apparatus to the second apparatus.

12. A network apparatus as claimed in claim 11, wherein the indication of the transmission link quality is indicative of a link quality from the first apparatus to the network apparatus.

13. A network apparatus as claimed in claim 11, wherein the network apparatus is further caused to:
transmit to the second apparatus an indication of a receive link quality of a link communicating data from the network apparatus to the second apparatus; and/or transmit to the second apparatus an indication of a transmit link quality of a link communicating data from the second apparatus to the network apparatus.

14. A network apparatus as claimed in claim 11, wherein the network apparatus is caused to:
provide an indication to the second apparatus of the quality of a transmission link from a third apparatus of the plurality of apparatus to the second apparatus.

15. A network apparatus as claimed in claim 11, wherein the network apparatus is further caused to:
compare said collected information to at least one threshold for determining what indication should be provided to the second apparatus.

16. A method comprising:
communicating, by an apparatus, with at least one other apparatus via a network apparatus;
receiving, by the apparatus, from the network apparatus for each of said at least one other apparatus an indication of a transmission link quality of a link extending from said at least one other apparatus to the apparatus; and
causing, by the apparatus, a display of the received transmission link quality indication(s).

17. A method as claimed in claim 16, wherein the indication(s) of the transmission link quality is indicative of a link quality from said at least one other apparatus to the network apparatus.

18. A method as claimed in claim 16, further comprising:
receiving from the network apparatus an indication of a receive link quality of a link extending from the network apparatus to the apparatus; and
displaying the received indication of the receive link quality.

19. A method as claimed in claim 16, further comprising:
receiving an input from a user in response to a display of at least one of said indications; and
in response to the received input, causing a property of the communication with said at least one other apparatus to be altered and/or investigated.

20. A method as claimed in claim 16, wherein the apparatus is caused to display at least one of said received indications by causing a display screen of the apparatus to render said indication immediately adjacent to a region of the display associated with a user associated with the apparatus to which said rendered indication relates.
